(19) United States
(12) Patent Application Publication
(10) Pub. No.: US 2013/0346896 A1
(43) Pub. Date: Dec. 26, 2013

(54) USER INTERFACE WITH EVENT PREDICTION

(71) Applicant: METAKINE INC., Montreal (CA)

(72) Inventor: Antoine Missout, Montreal (CA)

(73) Assignee: Metakine Inc., Montreal, QC (CA)

(21) Appl. No.: 13/708,290

(22) Filed: Dec. 7, 2012

Related U.S. Application Data
(60) Provisional application No. 61/663,160, filed on Jun. 22, 2012.

(51) Int. Cl. G06F 9/44; G06F 3/0486

(52) U.S. Cl. CPC G06F 9/4421; G06F 3/0486
USPC 715/769; 718/102; 715/856

(57) ABSTRACT

System and method for reducing processing delays when interfacing with a computing device. The method comprising predicting a user event using sensors or information stored in memory, and pre processing the command associated with the predicted user event before receiving a user input confirming the predicted user event. The preprocessing data is output to the user after receiving a user input confirming the predicted user event. Thereby, reducing processing delays associated with the user-event.

### CROSS-REFERENCE TO RELATED APPLICATIONS

This application claims priority of US provisional patent application No. 61/663,160 filed on Jun. 22, 2012 which is hereby incorporated by reference in its entirety.

### BACKGROUND

(a) Field

The subject matter disclosed generally relates to user interfaces.

(b) Related Prior Art

Processing speed in computing devices has tremendously increased in the past years. Nevertheless, delays between the sending of a command and the execution of the command are still felt by the user.

Interactions between the user and the computing device are known as user events. The action or state change that results from a user event can take a varying amount of time to complete. Pressing a key in a word processor will typically be processed extremely quickly, while compressing a long video stream may take hours. Most actions, however, will take a short but often noticeable amount of time.

In some instances, the delays are independent of the processing speed of the computing device. For instance, when the user launches the internet there is always latency between the time where the internet link is pressed and the time where the internet page is opened. Such delays are not only dependent on the speed of the processor but also on the internet connection, the bandwidth, the location of the server, etc.

Therefore, there is a need in the market for a method and system that decrease this latency and provide the user with an instantaneous feel when using a computing device.

### SUMMARY

According to an embodiment, there is provided a method for reducing processing delays when interfacing with a computing device, the method comprising:

predicting a user event;

processing at least a portion of a command associated with the predicted user event, thereby generating pre-processing data associated with the predicted user event;

receiving a user input selecting the predicted user event;

outputting the pre-processing data associated with the predicted user event after receiving the user input confirming selection of the predicted user event, thereby reducing processing delays associated with the command.

According to an aspect, predicting a user event comprises:

receiving sensor data from one or more sensors operatively connected to the computing device; and

processing the sensor data to identify a movement leading to the user event.

According to an aspect, the method further comprises:

projecting based on a direction of the movement, a destination for the movement on a display operatively connected to the computing device; and

returning the command associated with the destination for pre-processing.

According to an aspect, the method further comprises receiving the sensor data from one or more of: camera, IR sensor, motion sensor, pressure sensor, heat sensor, and light sensor.

According to an aspect, processing the sensor data to identify a movement comprises processing the sensor data to identify a user finger or a pointing object moving toward a button on a keyboard associated with the computing device.

According to an aspect, processing the sensor data to identify a movement comprises processing the sensor data to identify a user finger or a pointing object moving toward a certain area on a touch sensitive display associated with the computing device.

According to an aspect, the one or more sensors comprises a pointing device, the method further comprising:

detecting a dragging of a first file in a given direction on a display associated with the computing device;

identifying, based on the given direction, a destination program or a destination folder for the first file;

returning the command associated with the destination program or destination folder for pre-processing on the first file.

According to an aspect, the method further comprises:

gathering and storing profile data representing one or more of: user activities, user behavior, and user preferences;

predicting the user event based on said profile data when previously performed actions are repeated on the computing device.

According to an embodiment, there is provided a method for reducing processing delays when interfacing with a computing device, the method comprising:

predicting more than one user events;

processing, at least in portion, commands associated with the predicted user events to generate pre-processing data for commands associated with the predicted user events;

receiving a user input selecting one of the predicted user events;

outputting the pre-processing data associated with the selected user event after receiving the user input selecting the predicted user events, thereby reducing processing delays associated with the commands.

According to an embodiment, there is provided a system for reducing processing delays when interfacing with a computing device, the system comprising:

an input/output (I/O) interface for interfacing with a user;

a processor for processing a command associated with a user event received via the I/O interface; and

an intelligence module operatively connected to the processor and the I/O interface, the intelligence module being adapted to predict a user event and send the command associated with the predicted user event to the processor for pre-processing, thereby, producing pre-processing data associated with the predicted user event;

wherein the system outputs the pre-processing data only after receiving a user input selecting the predicted user event, thereby reducing processing delays associated with the predicted user event.

According to an aspect, the system receives sensor data from one or more sensors operatively connected to the computing device and processes the sensor data to identify a movement leading to the predicted user event.

According to an aspect, the system predicts based on a direction of the movement, a destination for the movement on a display operatively connected with the computing device, and sends the command associated with the destination to the processor for pre-processing.

According to an aspect, the one or more sensors include one or more of: camera, IR sensor, motion sensor, pressure sensor, heat sensor, and light sensor.

According to an aspect, the movement represents a user finger or a pointing object moving toward a button on a keyboard associated with the computing device.

According to an aspect, the movement represents a user finger or a pointing object moving toward a certain area on a touch sensitive display associated with the computing device.

According to an aspect, the one or more sensors comprises a pointing device, the intelligence module being adapted to:

detect a dragging of a first file in a given direction on a display associated with the computing device,

identify based on the given direction, a destination program or a destination folder for the first file; and

send the command associated with the destination program or destination folder to the processor for pre-processing on the first file.

According to an aspect, the system is adapted to gather and store profile data representing one or more of: user activities, user behavior, and user preferences, wherein the intelligence module predicts the user event based on said profile data when previously performed actions are repeated on the computing device.

According to an aspect, intelligence module predicts more than one user events and send the commands associated with each predicted user event to the processor for execution, wherein only processing data associated with the selected user event is output.

According to an aspect, the intelligence module is physically separate from the processor.

According to an aspect, the intelligence module is embedded in the processor.

In an embodiment, there is provided a method for reducing processing delays when interfacing with a computing device, the method comprising: predicting a user event using one or more sensors operatively connected to the computing device; processing at least a portion of the command associated with the predicted user event thereby defining pre-processed data associated with the predicted user event; receiving a user input selecting the predicted user event; outputting pre-processed data associated with the predicted user event after receiving the user input confirming selection of the predicted user event.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a flowchart illustrating the sequence of actions performed while executing a user event in conventional systems;

FIG. 2 is flowchart illustrating an exemplary sequence of actions performed while executing a user event in accordance with the presence embodiments;

FIG. 3 illustrates the operating system of an exemplary user device in accordance with an embodiment;

FIGS. 4a-4d illustrate an example of a user device comprising a prediction module in accordance with the present embodiments;

FIG. 4f illustrates different locations for providing/installing sensors that provide data that allows determining a user event;

FIG. 5 illustrates an exemplary method for predicting a user event using the movements of a pointing device on a tablet device;

FIG. 6 is a flowchart of a method for reducing processing delays when interfacing with a computing device, in accordance with an embodiment; and

FIG. 7 is a diagram of the hardware and operating environment in conjunction with which embodiments of the invention may be practiced.

It will be noted that throughout the appended drawings, like features are identified by like reference numerals.

### DETAILED DESCRIPTION

The embodiments now will be described more fully hereinafter with reference to the accompanying drawings, which form a part hereof, and which show, by way of illustration, specific embodiments by which the embodiments may be practiced. The embodiments are also described so that the disclosure conveys the scope of the invention to those skilled in the art. The embodiments may, however, be embodied in many different forms and should not be construed as limited to the embodiments set forth herein.

Among other things, the present embodiments may be embodied as methods or devices. Accordingly, the embodiments may take the form of an entirely hardware embodiment, an entirely software embodiment, an embodiment combining software and hardware aspects, etc. Furthermore, although the embodiments are described with reference to a laptop computer and a tablet device, they may also be implemented on desktops, portable devices, or any computing device having sufficient computing resources to implement the embodiments.

In the present embodiments, the user event may be predicted using sensors or otherwise before the user event actually occurs and a portion (or all) of the processing associated with the user-event is pre-performed before the user event is received. Results of the processing will only be displayed to the user after receiving the user event. For example, if the action associated with the user event is to open an internet page, a connection may be established and data of the internet page may be received and stored in memory without being displayed to the user. When the user event is confirmed, the web page may be displayed to the user immediately giving the user an instantaneous feel resulting in an improved user experience.

The current state of the user events processed by a computer, based on the inputs of sensors such as a mouse, keyboard, or touch screen, has been rather stable in the past years. Typical user events processing is done with the following Application Programming Interface (API) (or their equivalent) for a computer, laptop, or other processing hardware using a mouse:
mouseMoved
mouseDown
mouseDragged
mouseUp

Typically, these events give the timestamp of the event, location, and if applicable, which button was pressed in case of a multi-button mouse. In the case of a mouse with a scroll wheel, a distinct event can be sent detailing the movement. For a computer keyboard, the typical API is:
keyDown
keyUp

These events typically include timestamps. Some input device may also report the pressure on the key and send events when it changes (e.g. Playstation 3 controller buttons).

For a typical smartphone or touchscreen, the user events include:
touchBegan
touchMoved
touchEnded

These events typically include timestamp, location, and an identifier for the touch that began in the case of a multi-touch capable touch screen.

A typical tablet can send events such as:
tabletPoint
tabletProximity

The events can give the current location, pressure, tilt, rotation and proximity of the pointing device in relation to the table. All conventional user events represent current (or slightly past) events.

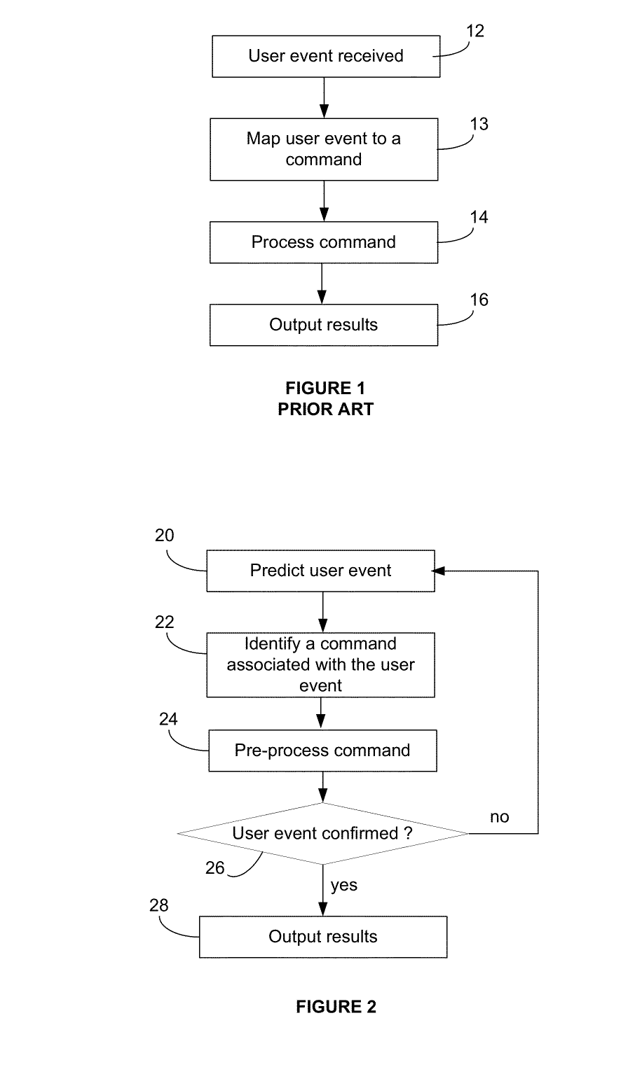

FIG. 1 is a flowchart illustrating the sequence of actions performed while executing a user event in conventional systems. As shown in FIG. 1, a user event is detected at step 12. At step 13, the user event is mapped to a command. The command corresponding to the user event is processed at step 14. Results of the command processing are output at step 16. In the sequence illustrated in FIG. 1, there is a always a delay between the time where the user performs an action (user event) and the time where the command associated with the action is recognized, processed and output. The present embodiments are intended to reduce such delays.

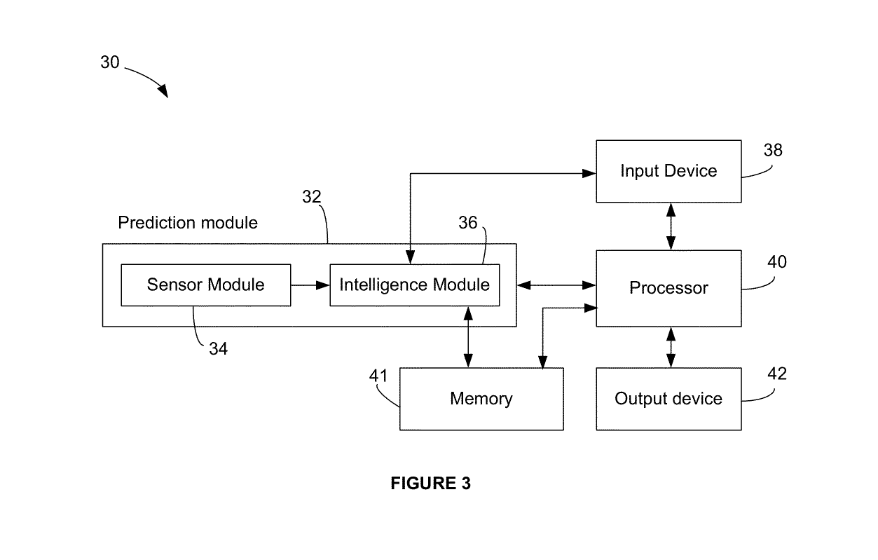

The present embodiments predict/estimate a possible user event and perform a portion of the processing associated with the predicted user event before the user event is received or confirmed. Whereby, if/when the user event is confirmed the results may be displayed to the user faster and in some cases instantaneously after confirming the user event. An example is illustrated in FIG. 2.

FIG. 2 is flowchart illustrating an exemplary sequence of actions performed while executing a user event in accordance with the present embodiments. As shown in FIG. 2, a user event may be predicted at step 20.

Step 22 comprises identifying a command associated with the predicted user event. For example, if the predicted user event is the intent to press the internet button on a keyboard, then the command associated with the user event would be to open an internet page. At step 24, the command is pre-processed before being confirmed by the user. In other words, a portion or all of the processing associated with a certain button/command may be performed/started by the processor before the user presses that button. If the user-event is confirmed at step 26, the results may be output at step 28 faster than the usual since the processing is pre-performed which also means that the processing latency is avoided. In an embodiment, if a portion of the processing is not yet done, it may be performed after the user event is received. In the event that the user event is not confirmed, the pre-processed data may be erased from memory or overwritten until the next user event is predicted (return to step 20). As shown in FIG. 2, a portion or all of the processing associated with the user event is pre-performed before the user event is confirmed/entered by the user, whereby, the results may be output to the user faster after the user event is received by the user which provides for an improved user experience.

In an embodiment, the user event may be predicted using an event-prediction module. The event prediction module may include sensors (and may not) and an intelligence module for interpreting the output of the sensors and predicting the user-event before the user-event is entered/confirmed by the user. The embodiments, may be implemented on a user device such a cellular phone, laptop, desktop, portable computing device, portable telephone, tablet or any computing device having an operating system which is capable of implementing the present embodiments. The sensors may be added or built-in the user device e.g. camera, mouse, touchscreen, IR sensors, motion sensor, pressure sensor, heat sensors, light sensors, etc. or any type of sensors that may be used for detecting/extracting location data and/motion data (or other types of data) that may be used for predicting a user event.

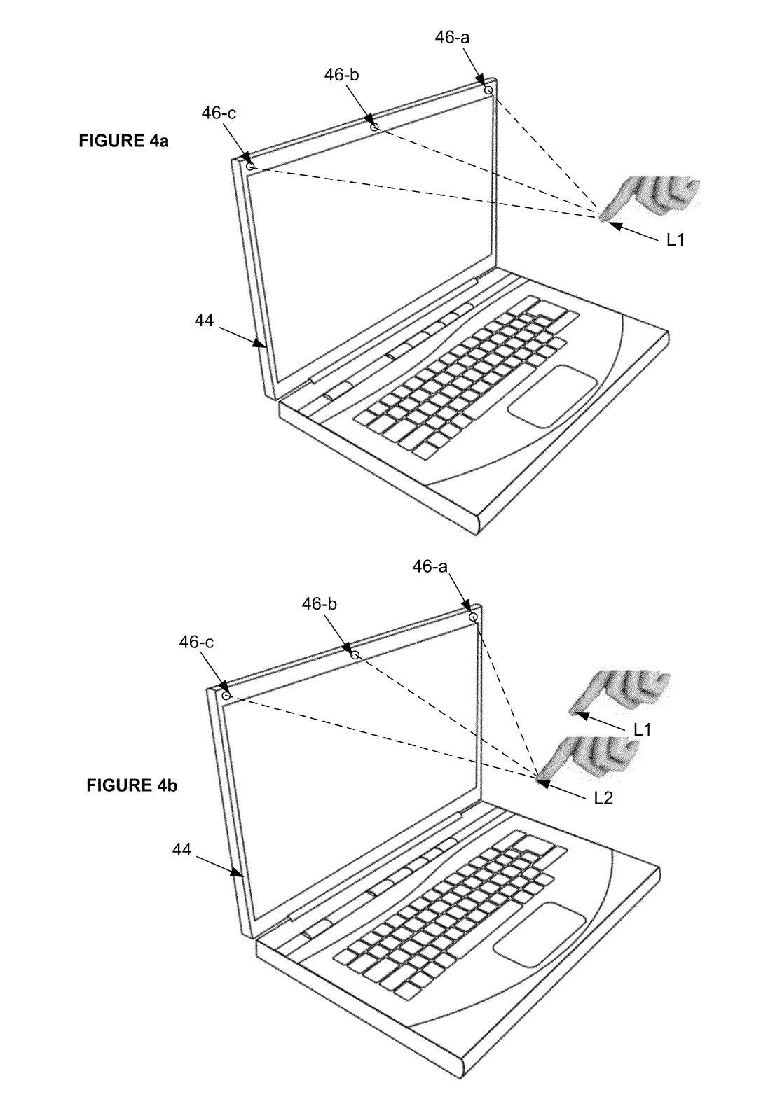

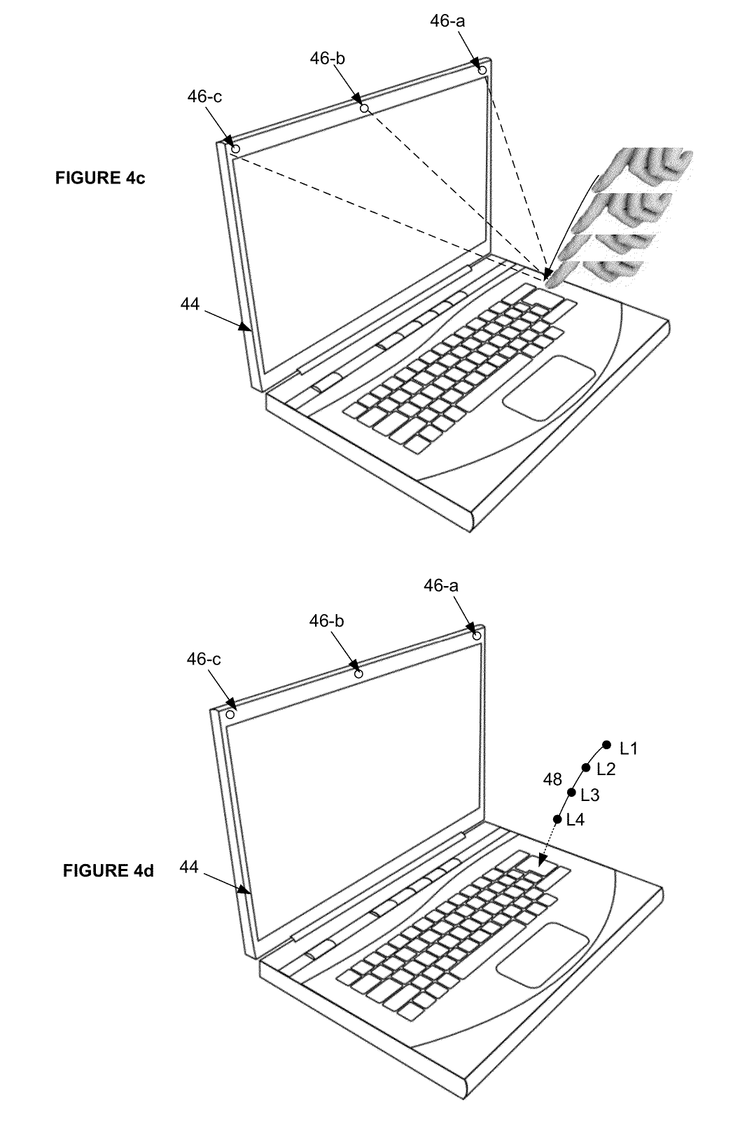

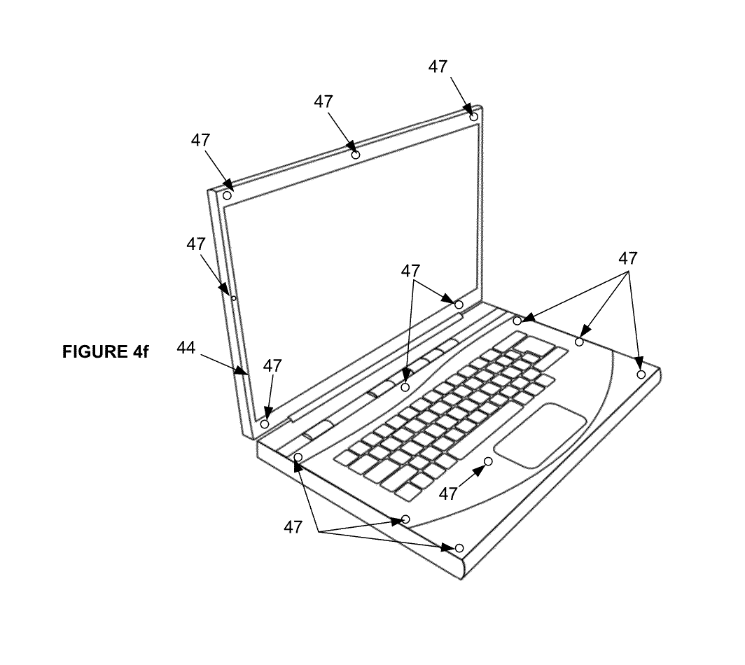

FIG. 3 illustrates an exemplary operating system of a user device in accordance with an embodiment. As shown in FIG. 3, the user device 30 includes a prediction module 32, an input device 38, a processor 40, and an output device 42. In an embodiment, the prediction module 32 may include a sensor module 34 including at least one sensor and an intelligence module 36 for predicting user events based on data output by the sensor module 34 before the events happens. An example is illustrated in connection with FIGS. 4a to 4d.

FIGS. 4a-4d illustrate an example of a user device comprising a prediction module in accordance with the present embodiments. In the example of FIGS. 4a to 4d, a user device 44 is illustrated comprising one or more sensors 46, e.g., imaging sensors, motion sensors, radars, etc. The sensors 46 may detect the user's hand motion as the user is moving their hand toward the keyboard. Sensor data output by the sensors 46 is sent to the intelligence module 36 to predict the user-event that the user is intending to enter before the user performs that entry.

In a non-limiting example of implementation, the sensors 46 may detect the user's finger at a different location with each sample. For example, sensors 46 will detect a first location L1 at the first sample, a second location L2 at the second sample, a third location L3 at the third sample, and so on. From these locations, the intelligence module may build a virtual trajectory 48 (see FIG. 4d) and estimate few buttons/characters/links/commands that could receive the user finger/hit. As more samples are received the probability tends to converge toward a single button whereby less-likely buttons/commands may be eliminated based on their location with respect to the direction of virtual trajectory. When the probability converges toward a single button, a predicted user event may be generated and the command associated with the single button may be pre-processed but the results may only be output after the user-event is confirmed.

In another example, the sensors 46 may be used to determine from the motion of the user's eyes, the object or file that the user is looking at, whereby the system may predict a user event based on the location/object that the user is looking at on the display.

While FIGS. 4a to 4d illustrate sensors provided on top of the screen of the portable device, it is to be understood that the embodiments are not limited to this configuration, and that various types of sensors 47 may be provided in any location on the user device, as exemplified in FIG. 4f.

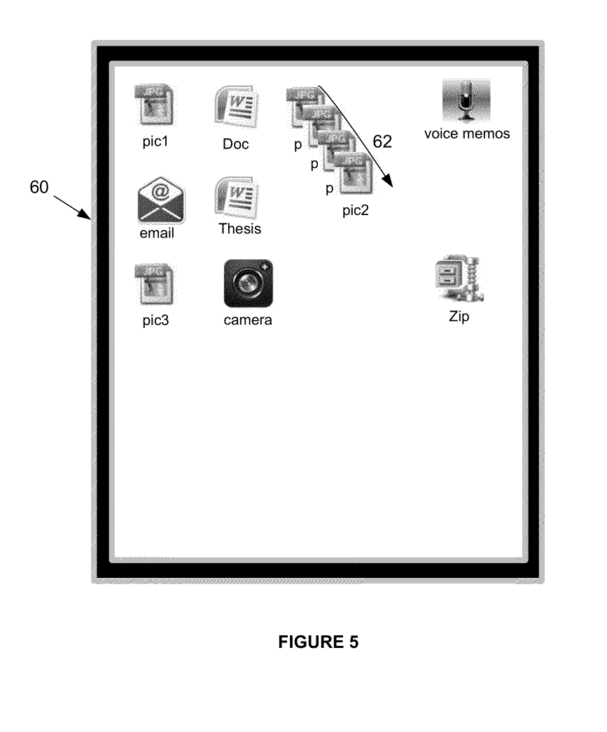

Another example of how the system may predict a user event is provided below with reference to FIG. 5. In the present example, the system may predict a user event using a pointing device such as a mouse or touchscreen or pen (aka pointing object), etc. FIG. 5 illustrates an exemplary method for predicting a user event using the movements of a pointing device on a tablet device. The method may be implemented on any computing device using a mouse or keyboard as pointing devices, or any computing device having a touchscreen, or a screen which allows the user to interface with the device using a pen such as PDAs or the like.

FIG. 5 illustrate a tablet device 60 comprising a plurality of applications/programs and files including a file compressing program (Zip), and a picture file named pic2. As shown in FIG. 5, the file pic2 is shown to be dragged on the screen. In an embodiment, the system may determine an approximate direction for the movement as defined by arrow 62 and project based on the direction of the movement a destination. The destination may be a program or folder. In the present example, the projection is the Zip program which is used to compress files. Accordingly, the system may determine that the user intends to compress the file and may begin to compress the pic2 file before the pic2 file is brought in contact with the Zip program.

In an embodiment, it is possible to pre-process more than one user-event and discard the data associated with unconfirmed user events after receiving confirmation of a selected user-event. For example, if two buttons exist beside each other on the user's keyboard wherein one button is associated with the MS Word™ program and the other button is associated with the Internet Explorer™ program and the user is moving their finger toward the two buttons, it is possible to pre-run the two programs in memory until the user confirms their selection. In which case, the program/page associated with the selected/pressed button may be displayed on the screen and pre-processing data associated with the non-selected program may be discarded.

In another embodiment, the intelligence module may perform the prediction based upon a pre-stored bank of data representing user preferences, activities, behaviour, and profile data. This data may be used to predict user events when similar situations occur or when previously performed actions are being repeated. Examples are provided below. It should be noted that the present embodiment may function with and without the presence of sensor data.

In a first example, assuming that the user is surfing the web and requests access to a website provided in two languages. In which case, the intelligence module may pre-select the language that the user always uses based on the profile data stored in memory. It may then proceed to load that page before receiving the user selection. When the user confirms the selection, the page may be displayed faster providing the user with an improved user experience.

In a further example, using the bank of data the intelligence module may detect the precise activities that the user performs in certain websites, and may therefore load the pages ahead of receiving the user events confirming the user instructions. For example, assuming that the webpage of Bank X offers a variety of services such as online banking, loans and mortgages, online trading etc. If the user visits the website of Bank X to perform online banking repeatedly/regularly, such activity may be registered in the bank of data and may be used by the intelligence module to order the processor to load the online banking page next time webpage of Bank X is visited. The system may then proceed to load the online banking page before receiving the user selection. When the user confirms the selection, the page may be displayed faster providing the user with an improved user experience.

Referring back to FIG. 3, predicted user events output by the intelligence module 36 may be sent to the processor 40 for pre-processing. When the user event is confirmed using an input device 38 such as the mouse, keyboard, voice command, touchscreen or the like, the pre-processed command may be output on an output device immediately, thereby eliminating at least a portion of the delay associated with the processing of the command associated with the user event.

It should be noted that although the intelligence module 36 is shown as being a separate element in FIG. 3, it may also be embedded within the processor 40. Accordingly, the intelligence module may be a separate physical component, and may also be implemented in the processor 40.

Accordingly, using various data from sensors or stored information, predicted user events can be generated that will represent unconfirmed, but possible (or likely) events in the near future. For every event API listed above, a pre-event could be introduced. In the touch screen case, we would add:
pre-touch Began
pre-touchMoved
pre-touchEnded

Such unconfirmed events could help pre-calculating the result of the actual action if the action is confirmed. The un-confirmed events could optionally include the probability of the event being confirmed and the predicted time of the confirmation.

In this example, the pre-touchBegan could be sent based on data from a motion sensor when the hand approaches the touchable surface. The pre-touchMoved could be sent based on pressure data indicating an increase on one-side of the touched surface and a decrease on the other side, and the pre-touchEnded could be sent based on a pressure decrease on all sides moments before the surface actually stops being touched.

These events could be calculated and produced depending on many information, such as:
location of the user hand, velocity and acceleration;
pressure on the touched surface;
area being looked at by the user;
electro-magnetic reading of the user brain; and
any other data that might help predicting future user actions.

Event prediction allows an application or computer to take pre-action before the event is confirmed, such as preparing or precalculating data in order to reduce the latency to complete the action once the user event is confirmed.

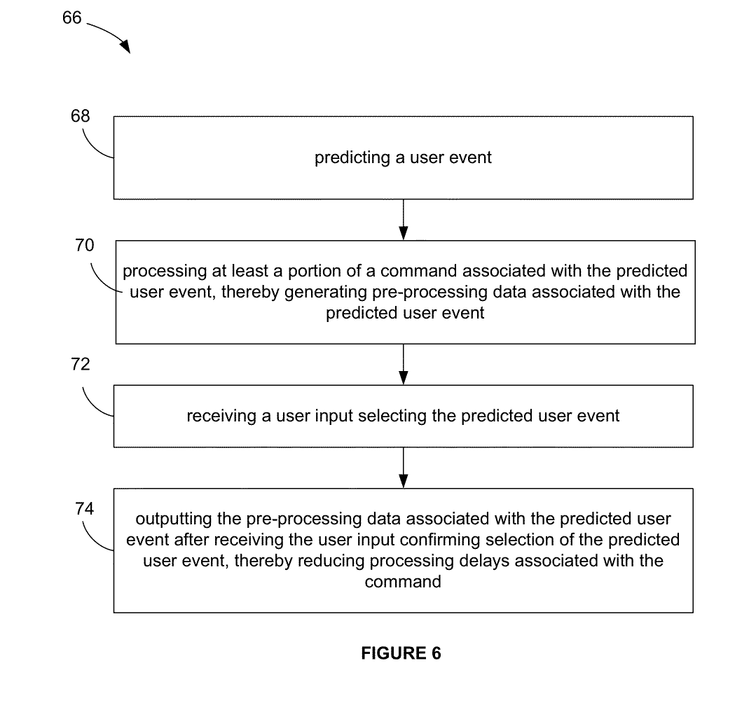

FIG. 6 is a flowchart of a method for reducing processing delays when interfacing with a computing device, in accordance with an embodiment. The method 66 begins at step 68 by predicting a user event. Step 70 comprises processing at least a portion of a command associated with the predicted user event, thereby generating pre-processing data associated with the predicted user event. Step 72 comprises receiving a user input selecting the predicted user event. Step 74 comprises outputting the pre-processing data associated with the predicted user event after receiving the user input confirming selection of the predicted user event, thereby reducing processing delays associated with the command.

### Hardware and Operating Environment

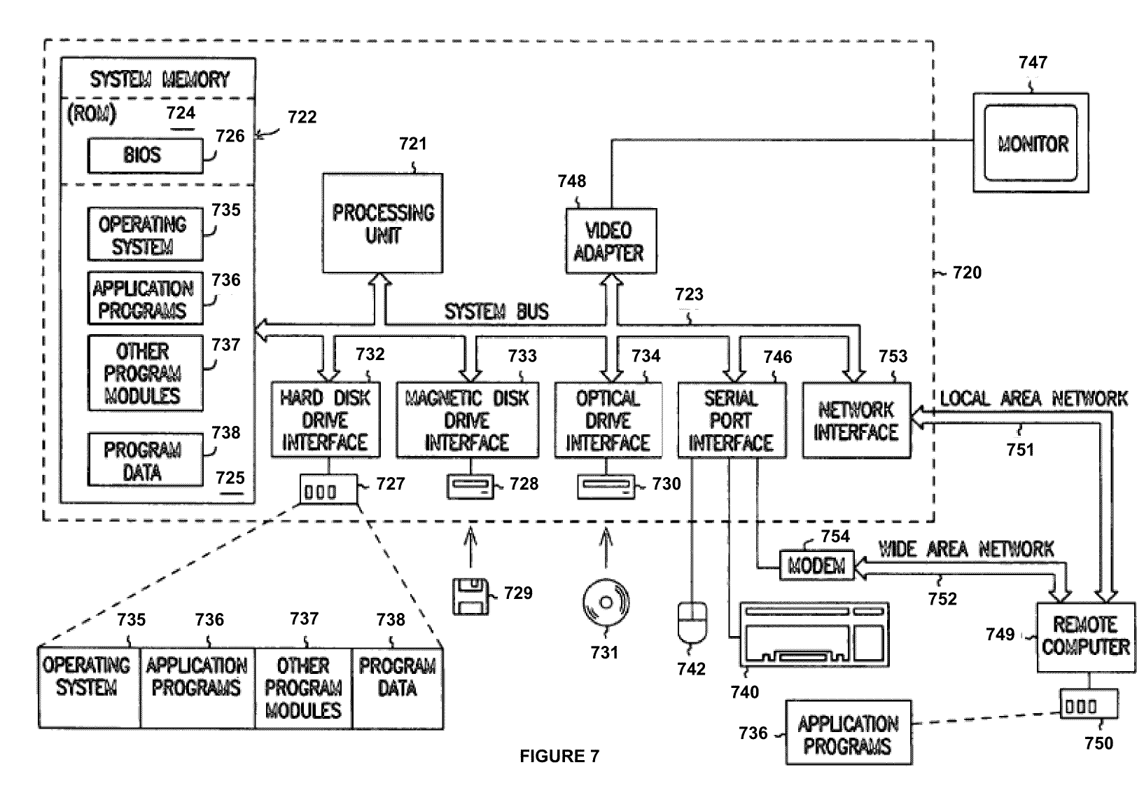

FIG. 7 is a diagram of the hardware and operating environment in conjunction with which embodiments of the invention may be practiced. The description of FIG. 7 is intended to provide a brief, general description of suitable computer hardware and a suitable computing environment in conjunction with which the invention may be implemented. Although not required, the invention is described in the general context of computer-executable instructions, such as program modules, being executed by a computer, such as a personal computer, a hand-held or palm-size computer, or an embedded system such as a computer in a consumer device or specialized industrial controller. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computing environments where tasks are performed by remote processing devices that are linked through a communications network. In a distributed computing environment, program modules may be located in both local and remote memory storage devices.

The exemplary hardware and operating environment of FIG. 7 for implementing the invention includes a general purpose computing device in the form of a computer 720, including a processing unit 721, a system memory 722, and a system bus 723 that operatively couples various system components including the system memory to the processing unit 721. There may be only one or there may be more than one processing unit 721, such that the processor of computer 720 comprises a single central-processing unit (CPU), or a plurality of processing units, commonly referred to as a parallel processing environment. The computer 720 may be a conventional computer, a distributed computer, or any other type of computer; the invention is not so limited.

The system bus 723 may be any of several types of bus structures including a memory bus or memory controller, a peripheral bus, and a local bus using any of a variety of bus architectures. The system memory may also be referred to as simply the memory, and includes read only memory (ROM) 724 and random access memory (RAM) 725. A basic input/output system (BIOS) 726, containing the basic routines that help to transfer information between elements within the computer 720, such as during start-up, is stored in ROM 724. In one embodiment of the invention, the computer 720 further includes a hard disk drive 727 for reading from and writing to a hard disk, not shown, a magnetic disk drive 728 for reading from or writing to a removable magnetic disk 729, and an optical disk drive 730 for reading from or writing to a removable optical disk 731 such as a CD ROM or other optical media. In alternative embodiments of the invention, the functionality provided by the hard disk drive 727, magnetic disk 729 and optical disk drive 730 is emulated using volatile or non-volatile RAM in order to conserve power and reduce the size of the system. In these alternative embodiments, the RAM may be fixed in the computer system, or it may be a removable RAM device, such as a Compact Flash memory card.

In an embodiment of the invention, the hard disk drive 727, magnetic disk drive 728, and optical disk drive 730 are connected to the system bus 723 by a hard disk drive interface 732, a magnetic disk drive interface 733, and an optical disk drive interface 734, respectively. The drives and their associated computer-readable media provide nonvolatile storage of computer-readable instructions, data structures, program modules and other data for the computer 720. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 729, optical disk 731, ROM 724, or RAM 725, including an operating system 735, one or more application programs 736, other program modules 737, and program data 738. A user may enter commands and information into the personal computer 720 through input devices such as a keyboard 740 and pointing device 742. Other input devices (not shown) may include a microphone, joystick, game pad, satellite dish, scanner, touch sensitive pad, or the like. These and other input devices are often connected to the processing unit 721 through a serial port interface 746 that is coupled to the system bus, but may be connected by other interfaces, such as a parallel port, game port, or a universal serial bus (USB). In addition, input to the system may be provided by a microphone to receive audio input.

A monitor 747 or other type of display device is also connected to the system bus 723 via an interface, such as a video adapter 748. In one embodiment of the invention, the monitor comprises a Liquid Crystal Display (LCD). In addition to the monitor, computers typically include other peripheral output devices (not shown), such as speakers and printers.

The computer 720 may operate in a networked environment using logical connections to one or more remote computers, such as a remote computer 749. These logical connections are achieved by a communication device coupled to or a part of the computer 720; the invention is not limited to a particular type of communications device. The remote computer 749 may be another computer, a server, a router, a network PC, a client, a peer device or other common network node, and typically includes many or all of the elements described above relative to the computer 720, although only a memory storage device 750 has been illustrated in FIG. 7. The logical connections depicted in FIG. 7 include a local-area network (LAN) 751 and a wide-area network (WAN) 752. Such networking environments are commonplace in offices, enterprise-wide computer networks, intranets and the Internet.

When used in a LAN-networking environment, the computer 720 is connected to the local network 751 through a network interface or adapter 753, which is one type of communications device. When used in a WAN-networking environment, the computer 720 typically includes a modem 754, a type of communications device, or any other type of communications device for establishing communications over the wide area network 752, such as the Internet. The modem 754, which may be internal or external, is connected to the system bus 723 via the serial port interface 746. In a networked environment, program modules depicted relative to the personal computer 720, or portions thereof, may be stored in the remote memory storage device. It is appreciated that the network connections shown are exemplary and other means of and communications devices for establishing a communications link between the computers may be used.

The hardware and operating environment in conjunction with which embodiments of the invention may be practiced has been described. The computer in conjunction with which embodiments of the invention may be practiced may be a conventional computer a hand-held or palm-size computer, a computer in an embedded system, a distributed computer, or any other type of computer; the invention is not so limited. Such a computer typically includes one or more processing units as its processor, and a computer-readable medium such as a memory. The computer may also include a communications device such as a network adapter or a modem, so that it is able to communicatively couple other computers.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A method for reducing processing delays when interfacing with a computing device, the method comprising:
predicting a user event;
processing at least a portion of a command associated with the predicted user event, thereby generating pre-processing data associated with the predicted user event;
receiving a user input selecting the predicted user event;
outputting the pre-processing data associated with the predicted user event after receiving the user input confirming selection of the predicted user event, thereby reducing processing delays associated with the command.

2. The method of claim 1, wherein predicting a user event comprises:
receiving sensor data from one or more sensors operatively connected to the computing device; and
processing the sensor data to identify a movement leading to the user event.

3. The method of claim 2, further comprising:
projecting based on a direction of the movement, a destination for the movement on a display operatively connected to the computing device; and
returning the command associated with the destination for pre-processing.

4. The method of claim 3, further comprising receiving the sensor data from one or more of: camera, IR sensor, motion sensor, pressure sensor, heat sensor, and light sensor.

5. The method of claim 4, processing the sensor data to identify a movement comprises processing the sensor data to identify a user finger or a pointing object moving toward a button on a keyboard associated with the computing device.

6. The method of claim 4, processing the sensor data to identify a movement comprises processing the sensor data to identify a user finger or a pointing object moving toward a certain area on a touch sensitive display associated with the computing device.

7. The method of claim 2, wherein the one or more sensors comprises a pointing device, the method further comprising:
detecting a dragging of a first file in a given direction on a display associated with the computing device;
identifying, based on the given direction, a destination program or a destination folder for the first file;
returning the command associated with the destination program or destination folder for pre-processing on the first file.

8. The method of claim 1, further comprising:
gathering and storing profile data representing one or more of: user activities, user behavior, and user preferences;
predicting the user event based on said profile data when previously performed actions are repeated on the computing device.

9. A method for reducing processing delays when interfacing with a computing device, the method comprising:
predicting more than one user events;
processing, at least in portion, commands associated with the predicted user events to generate pre-processing data for commands associated with the predicted user events;
receiving a user input selecting one of the predicted user events;
outputting the pre-processing data associated with the selected user event after receiving the user input selecting the predicted user events, thereby reducing processing delays associated with the commands.

10. A system for reducing processing delays when interfacing with a computing device, the system comprising:
an input/output (I/O) interface for interfacing with a user;
a processor for processing a command associated with a user event received via the I/O interface; and
an intelligence module operatively connected to the processor and the I/O interface, the intelligence module being adapted to predict a user event and send the command associated with the predicted user event to the processor for pre-processing, thereby, producing pre-processing data associated with the predicted user event;
wherein the system outputs the pre-processing data only after receiving a user input selecting the predicted user event, thereby reducing processing delays associated with the predicted user event.

11. The system of claim 10, wherein the system receives sensor data from one or more sensors operatively connected to the computing device and processes the sensor data to identify a movement leading to the predicted user event.

12. The system of claim 11, wherein the system predicts based on a direction of the movement, a destination for the movement on a display operatively connected with the computing device, and sends the command associated with the destination to the processor for pre-processing.

13. The system of claim 12, wherein the one or more sensors include one or more of: camera, IR sensor, motion sensor, pressure sensor, heat sensor, and light sensor.

14. The system of claim 13, wherein the movement represents a user finger or a pointing object moving toward a button on a keyboard associated with the computing device.

15. The system of claim 13, wherein the movement represents a user finger or a pointing object moving toward a certain area on a touch sensitive display associated with the computing device.

16. The system of claim 11, wherein the one or more sensors comprises a pointing device, the intelligence module being adapted to:
detect a dragging of a first file in a given direction on a display associated with the computing device,
identify based on the given direction, a destination program or a destination folder for the first file; and
send the command associated with the destination program or destination folder to the processor for pre-processing on the first file.

17. The system of claim 11, wherein the system is adapted to gather and store profile data representing one or more of: user activities, user behavior, and user preferences, wherein the intelligence module predicts the user event based on said profile data when previously performed actions are repeated on the computing device.

18. The system of claim 10, wherein the intelligence module predicts more than one user events and send the commands associated with each predicted user event to the processor for execution, wherein only processing data associated with the selected user event is output.

19. The system of claim 10, wherein the intelligence module is physically separate from the processor.

20. The system of claim 10, wherein the intelligence module is embedded in the processor.
